(19) United States
(12) Patent Application Publication
(10) Pub. No.: US 2011/0210555 A1
(43) Pub. Date: Sep. 1, 2011

(54) GAS TURBINE DRIVEN ELECTRIC POWER SYSTEM WITH CONSTANT OUTPUT THROUGH A FULL RANGE OF AMBIENT CONDITIONS

(76) Inventors: Jian Y. Xia, Orlando, FL (US); Adam D. Plant, Orlando, FL (US); Hans-Juergen Kiesow, Orlando, FL (US); Martin Ferdinand Urban, Erlangen (DE)

(21) Appl. No.: 12/713,604

(22) Filed: Feb. 26, 2010

(51) Int. Cl. F02C 9/00; F01K 23/06; H02K 7/18

(52) U.S. Cl. 290/52; 60/773; 60/670

(57) ABSTRACT

A gas turbine compressor (28A, 28B) sized to support respective maximum design points of other gas turbine driven electrical power generating system components (30, 32, 38, 46, 58, 68) during a least dense ambient condition within a design range of ambient conditions. A variable inlet (72) on the compressor automatically modulates to modulate airflow to supply just the amount needed to produce a rated output of the system throughout the full design range of ambient conditions. This safely and economically maintains rated power system output (94) over a full range of ambient conditions.

### FIELD OF THE INVENTION

This invention relates to industrial gas turbines in single cycle and combined cycle power plant systems.

### BACKGROUND OF THE INVENTION

The first gas turbine designs were used for airplane applications, which require maximum output at take-off and reduced power during cruise. These engines were designed to obtain maximum thrust by matching the maximum output from the compressor to the turbine section. This philosophy was carried over to the first applications of gas turbines as power drives for other applications. During the 1950's, the first applications for electrical power generation were made with engines that were small in output by today's standards and were not considered major suppliers for power generation. As gas turbine technology evolved with the development of combined cycle applications and larger capacity engines, the design philosophy of matching the maximum compressor capability (mass flow rate) to a turbine section at a base load design point was continued. This has resulted in gas turbine electrical power plants that have large variations in power output with changes in ambient conditions, since the density of the ambient air may be less than the assumed design point conditions on any given day, and the compressor may thus be incapable of supplying its full design mass flow rate, and the downstream components such as the combustor and turbine must then be throttled back to match the actual mass flow output of the compressor. This reduction in power output usually occurs coincident with times of peak power demand, such as on unusually hot days. Power output may change on the order of 30% with a change in ambient temperature from 90° F. to 10° F. for example. To compensate for the loss in power with changes in ambient conditions, some designs utilize steam augmentation (injecting steam into the gas turbine at the combustor), wet compression (injecting water into the compressor inlet), or afterburners. These methods add expense and are not practical in all areas, such as where water is a scarce resource.

### BRIEF DESCRIPTION OF THE DRAWINGS

The invention is explained in the following description in view of the drawings that show:

FIG. 1 is a schematic view of an exemplary prior art combined cycle power plant.

FIG. 2 is a schematic view of a gas turbine electrical power generating system according to aspects of the invention.

FIG. 3 is a schematic view of a variable inlet vane ring.

FIG. 4 is a graph of power output variation with ambient temperature using gas turbines of three different designs.

FIG. 5 is schematic view of a combined cycle power plant according to aspects of the invention.

### DETAILED DESCRIPTION OF THE INVENTION

The present inventors have discovered a new gas turbine engine configuration which provides both cost reduction and operational improvement. The inventors have recognized that the prior art approach to gas turbine engine design, i.e. matching the compressor to the turbine at a base load design point, results in the compressor being the limiting component for operations during non-optimal ambient conditions. The compressor of a prior art gas turbine driven electrical power system is always operating at maximum output when the plant is called to produce its maximum electrical output. However, the downstream components of the system, such as the combustor, gas turbine, electrical generators, heat recovery steam generators (HRSG), steam turbine and balance of plant, will only be operating at maximum output when the ambient conditions are adequate for the compressor to produce its design maximum mass flow rate. During sub-optimal ambient conditions, such as at high temperatures, the compressor will produce less mass flow than its design mass flow, and therefore, all downstream components of the system must be operated at below their respective maximum design capacity because the compressor is the limiting component in the system. All down stream components are sized for the maximum expected output of the compressor, but they normally operate at less than maximum capacity due to less than optimum ambient conditions and loss in engine capability over time with aging. The cost for all the supporting equipment is therefore not optimum.

A gas-turbine-driven electric power generating system according to an embodiment of the invention has a compressor sized to produce an airflow that is adequate to support maximum design points of the other system components during a least-dense ambient condition within the system design range of ambient conditions. The compressor is designed to operate effectively (i.e. without surging or other undesirable operating conditions) to produce adequate compressed airflow to support full power operation of the system over a full range of least-favorable to most-favorable ambient conditions. A variable inlet on the compressor may be used to automatically modulate the inlet airflow for full power output despite varying ambient conditions, and to restrict mass airflow to the needed amount. A margin of capacity may be included in the compressor to compensate for system efficiency degradation with time, so the system maintains a rated output over its entire design lifetime.

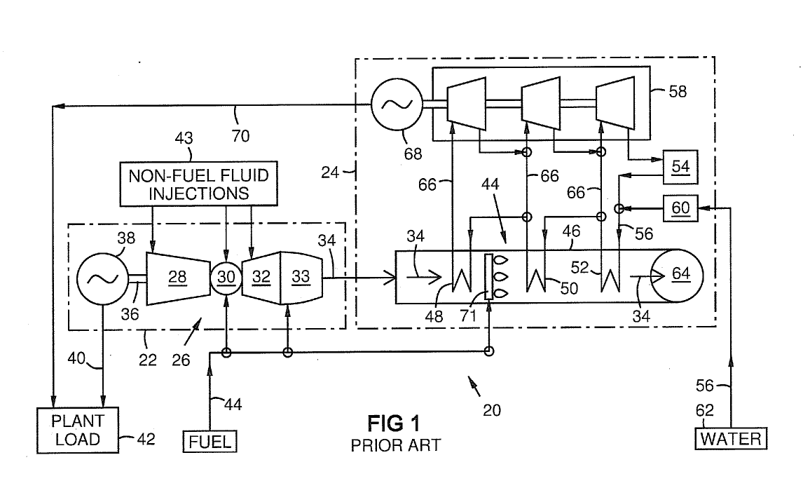

FIG. 1 is a schematic diagram of a prior art combined cycle electric power generating system 20 with a gas turbine portion 22, and a steam turbine portion 24. A gas turbine engine 26 has a compressor 28, a combustor 30, a turbine 32, an afterburner 33, an exhaust flow 34, and a power output shaft 36 that drives a generator 38 for electrical output 40 to a load 42. A fuel flow 44 is provided to the combustor 30 and afterburner 33. A non-fuel fluid 43 such as water or steam may be injected at various points in the working gas path of the engine 26 to add mass flow and/or reduce temperature. The steam turbine portion 24 has a heat recovery steam generator (HRSG) 44 with an exhaust gas duct 46 and one or more heat exchangers 48, 50, 52 that transfer heat from the exhaust flow 34 to water 56. This generates steam 66 for steam turbines 58. The heat exchangers 48, 50, 52 use water pumped 60 from an external water source 62 and/or recovered from a condenser 54. The exhaust gas 34 flows over the heat exchangers 48, 50, 52 and transfers heat to them, then exits the system via an exhaust stack 64. The steam turbines 58 drive a generator 68 for electrical output 70. Supplementary heating of the exhaust gas flow 34 may be provided for peak demand by the afterburner 33 and/or burners 71 in the HRSG 46.

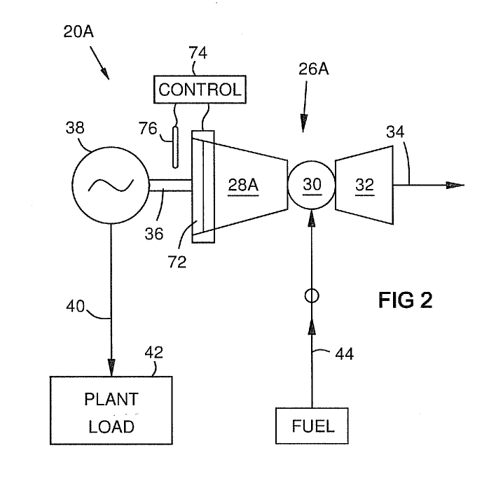

FIG. 2 schematically illustrates a gas-turbine-driven electrical power generating system 20A with a compressor 28A that has enough capacity to support the combustor 30 at its maximum design point during a least favorable ambient condition. For example, at a given installation site, the least dense expected ambient air condition may be 110° F., 40% relative humidity, and a pressure of 13.0 pounds per square inch. In this example, the compressor 28A is designed to supply enough compressed air at this ambient condition to operate the combustor 30 (and other downstream components) at its maximum design point. Additional capacity may be built into the compressor to compensate for normal degradation of the system efficiency over time. The gas turbine 32, the electrical generator 36, and other power system components such as transformers and fuel compressors, may be matched in capacity to the combustor 30 at their respective maximum design points.

The system 20A of FIG. 2 is thus capable of producing its maximum design power output over an entire range of ambient conditions, unlike the prior art system 20 of FIG. 1 which is incapable of producing its maximum design power output when the ambient conditions are less favorable than at the base load design point ambient conditions. Furthermore, the non-compressor components of system 20A of FIG. 2 can be operated at their respective maximum design capacities during non-favorable ambient conditions, whereas, the non-compressor components of the prior art system 20 of FIG. 1 must be throttled back during non-favorable ambient conditions. Accordingly, the system 20A is more cost effective than the prior art system 20 because the majority of the system (everything except the compressor) can be operated at full capacity over the full ambient condition range, whereas in the prior art system 20, the majority of the system (everything except the compressor) must be operated at less than full capacity for all sub-optimal ambient conditions, which is the majority of the time. The performance of system 20A is advantageous to the operation of a power grid because it is always available to produce its maximum design power output, whereas the output of the prior art system 20 will vary with ambient conditions, and therefore, its contribution of power to the grid is difficult to predict.

“Maximum design point” or “maximum design power output” herein is an operating level of a system or component that maximizes its power output or throughput under continuous operation without accelerated wear or loss of safety or efficiency. It also may be called the rated output. For example, an electrical power generating system or plant may have a rated output of 200 MW. Industry-accepted tolerances may apply. “Design range of ambient conditions” herein means a range of atmospheric conditions under which a system or component is designed to operate.

The compressor 28A supports the maximum design point of the engine 26A even at the least dense expected ambient condition. Therefore, any more favorable ambient condition can produce excessive airflow from the compressor. In one embodiment, this may be compensated by a variable inlet 72 of the compressor using control logic 74 and a control mechanism that adjusts the inlet 72 in response to changing ambient conditions to produce the rated power output of the gas turbine engine throughout a full design range of ambient atmospheric conditions. A sensor 76 at the inlet or in the compressor may provide input on ambient conditions and/or mass flow conditions to the control logic 74. Variable inlet guide vanes may provide a mechanism to vary the inlet 72 as later described.

Each component of the gas turbine engine 26A downstream of the compressor 28A, and each component of the electrical power generating system 20A, may operate continuously at its respective maximum design point, providing full utilization of all components at full efficiency under all conditions. No capacity is idle anywhere except at times in the compressor, minimizing cost of the system 20A for a given rated output.

This changes the economics and operation of power systems. No longer will system output decrease as the air density decreases, requiring a utility with a given load requirement to compensate for the expected loss in power. In addition, all components that comprise a system (other than the compressor) can be operated at their design point at all times, maximizing capital utilization. No longer will customers buy a system for a given load only to watch the power decrease with ambient temperature and with time as the system degrades, instead the variable guide vanes will modulate open to compensate for less than optimal ambient conditions and for normal wear within design limits. All of this is accomplished without reducing the life of components or over-firing the engine.

For a gas turbine system of 200 MW simple cycle output or 300 MW combined cycle output, the larger compressor is expected to add $0.5 to $1.0 million dollars to the engine cost. But in the environment of the northeast United States, a system designed per the present invention, when compared to the prior art systems, will produce on average about 45 MW more output per day during the year, and generate about $25 million additional revenue per year for a base-loaded power plant from the same capital expenditure plus the additional cost for the compressor. This greatly increases the value of such a plant.

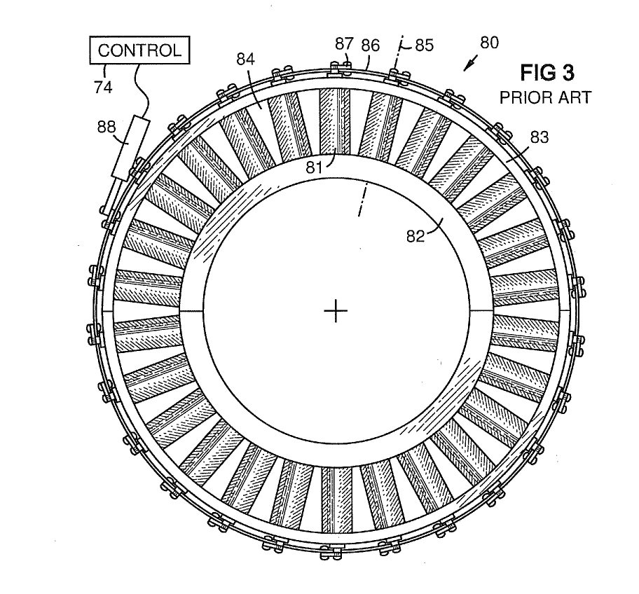

FIG. 3 schematically illustrates a variable inlet vane ring 80 as known in the art. Variable inlet guide vanes 81 are mounted in a circular array between inner and outer support rings 82, 83. An airflow passage 84 is defined between each pair of vanes 81. The sum of the airflow passages 84 defines an inlet area or aperture of the compressor. Each vane 81 is mounted to rotate about a radial axis 85. The vanes may be rotated in unison by an actuator ring 86 and a linkage 87 operated by an actuator 88 under commands from control logic 74. Rotating the vanes 81 varies the inlet area of the compressor 28A. Alternate designs of variable inlet guide vanes are known in the art. Any of these may be used in the present invention to ensure smooth operation of the compressor 28A over its entire range, as well as any other means for varying mass flow rate through the compressor.

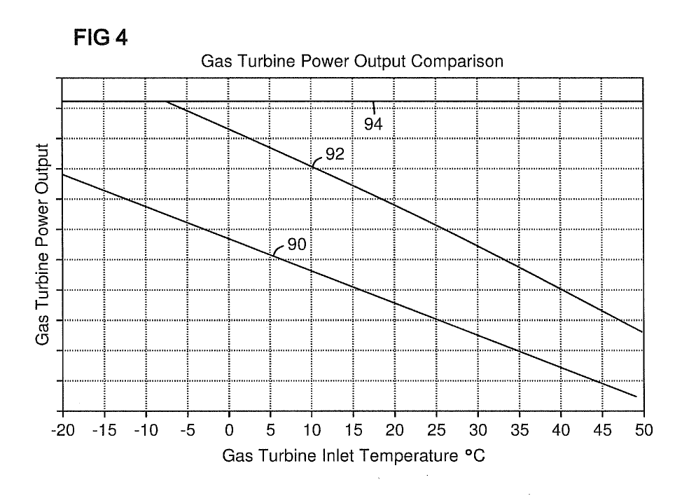

FIG. 4 illustrates how gas turbine engine power varies with ambient temperature in a non-compensated engine 90; in an engine 92 compensated per the prior art not including supplemental burners; and an engine 94 per the present invention, also without supplemental burners. The present invention eliminates the need for supplemental burners, while providing the maximum design output of the power system over a full range of expected ambient conditions.

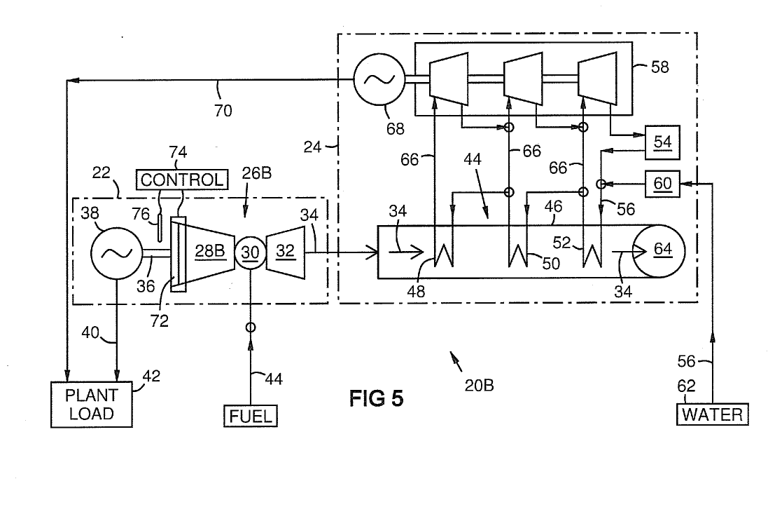

FIG. 5 is schematic diagram of a combined cycle electrical power generating system 20B according to aspects of the invention. A compressor 28B is sized to maintain sufficient airflow to produce a rated power output at respective maximum design points of components of the system throughout a full design range of ambient atmospheric conditions. Other components, such as fuel compressors, electrical generators, transformers, steam turbines, heat recovery steam generators, condensers, feed water heaters, and the like may all be matched to each other in capacity at their respective maximum design points. This maximizes the utilization and minimizes the cost of these other components per unit output of electricity. Additional capacity may be built into the compressor to compensate for normal degradation of component and system efficiency over time. The control logic 74 may operate the variable inlet 72 to support a continuous maximum design output or rated output of the combined cycle electrical power generating system 20B, throughout a full range of ambient atmospheric conditions over the lifetime of the system 20B.

In FIG. 5 no supplemental burners are shown. The afterburner 32 and duct burner 71 of FIG. 1 may be eliminated, because all of the components of the system 20B can operate at their respective maximum capacity design points without extra burners. Non-fuel fluid injections 43 for power enhancement may not be needed for the same reason.

The rated power output of the electrical power generating system 20A, 20B may be defined at a reference ambient condition, such as International Standards Organization ISO 2314 or ISO 3977-2, or it may be defined at an average ambient condition at the installation site. However, despite departures from the reference condition the compressor provides sufficient airflow to produce constant system output at the maximum design point of the other components of the system throughout a full design range of ambient atmospheric conditions. Thus, the system 20A, 20B may have a rated power output over the entire design range of ambient conditions.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A gas turbine driven electric power generating system characterized by a compressor of the system being operative to provide a mass flow of compressed air to a combustor of the system sufficient to support operation of the combustor at a maximum design point throughout a full design range of ambient atmospheric conditions.

2. The system of claim 1 further characterized by:
a gas turbine connected to the combustor and matched to the combustor to produce a maximum design power output of the gas turbine at the maximum design point of the combustor;
a variable inlet on the compressor; and
control logic and a control mechanism that adjusts the variable inlet of the compressor in response to ambient air conditions to support the operation of the combustor at its maximum design point throughout the full design range of ambient atmospheric conditions.

3. The system of claim 2, wherein the control logic and the control mechanism adjust the variable inlet of the compressor to provide a constant mass flow of compressed air to the combustor throughout the full design range of ambient atmospheric conditions.

4. The system of claim 2, wherein the control mechanism comprises a variable inlet vane ring in the compressor, comprising vanes that turn on respective axes to vary a total air inlet area of the compressor.

5. The system of claim 2, wherein a maximum design power output of the system is produced at the maximum design point of the combustor without an operating afterburner throughout the full design range of ambient atmospheric conditions.

6. The system of claim 5, comprising a heat recovery steam generator (HRSG) that receives exhaust heat energy from the gas turbine, and a steam turbine that receives steam from the HRSG, wherein the maximum design power output of the system is produced in a combined cycle throughout the full design range of ambient atmospheric conditions without a supplemental burner in the HRSG.

7. A gas turbine driven electrical power generating system comprising:
a combustor, a gas turbine, and an electrical generator of the system all being sized to operate at respective maximum design points when the system is producing a rated electrical power output; and
a compressor of the system sized to provide sufficient air to the combustor to support operation of the combustor, the gas turbine, and the electrical generator at their respective maximum design points throughout a design range of ambient atmospheric conditions.

8. The system of claim 7, further comprising a margin of capacity in the compressor adequate to compensate for an expected degree of system efficiency degradation over a life of the system.

9. The system of claim 8 wherein the rated electrical power output of the system is defined at a reference ambient air condition, and the system further comprises:
a variable inlet on the compressor; and
control logic and a control mechanism that adjusts the variable inlet in response to changing ambient air conditions to provide sufficient air to the combustor to produce the rated electrical power output of the system throughout the full design range of ambient atmospheric conditions over the life of the system.

10. The system of claim 9, wherein the control logic and the control mechanism adjust the variable inlet of the compressor to provide a constant mass flow of air to the combustor throughout the full design range of ambient atmospheric conditions over the life of the system.

11. The system of claim 9, wherein the control mechanism comprises a plurality of vanes in a circular array in the compressor, wherein each vane turns on a respective axis to vary an air inlet area of the compressor.

12. The system of claim 7, wherein the rated electrical power output of the system is produced throughout the full design range of ambient atmospheric conditions without an afterburner.

13. The system of claim 12, further comprising a heat recovery steam generator (HRSG) that receives exhaust heat energy from the gas turbine, and a steam turbine that receives steam from the HRSG, wherein the rated electrical power output of the system is produced in a combined cycle throughout the full design range of ambient atmospheric conditions without a supplementary burner in the HRSG.

14. A method of configuring a gas turbine engine comprising:
matching a gas turbine to a combustor to produce a rated power output of a gas turbine engine at a maximum design capacity of both the combustor and the gas turbine at a reference ambient air condition;
sizing a compressor to provide sufficient compressed air to the combustor to produce the rated power output over a range of ambient conditions including a least dense expected ambient air condition;
combining the compressor, the combustor, and the gas turbine;
providing control logic and a control mechanism that adjusts mass airflow through the compressor in response to changing ambient air conditions to produce the rated power output over the range of ambient conditions without an afterburner.

15. The method of claim 14, further comprising sizing the compressor to provide sufficient compressed air to the combustor to produce the rated power output during the least dense expected ambient air condition combined with a predicted degradation of efficiency of the gas turbine engine with a period of usage.

16. The method of claim 15, further comprising sizing a heat recovery steam generator (HRSG) to be powered by an exhaust heat of the gas turbine engine to produce a rated thermal energy output of the HRSG at a full design capacity of the HRSG at the reference ambient air condition.

17. The method of claim 16, further comprising combining the gas turbine engine, the HRSG, a steam turbine powered by the HRSG, and an electrical generator, to produce a combined-cycle electrical power system that produces a maximum design electrical output at the rated power output of the gas turbine engine without an afterburner and without a supplemental burner in the HRSG.
